(19) United States
(12) Patent Application Publication
(10) Pub. No.: US 2006/0159466 A1
(43) Pub. Date: Jul. 20, 2006

(54) Offset quadrature phase-shift-keying method and optical transmitter using the same

(75) Inventors: Hoon Kim, Suwon-si (KR); Seong-Taek Hwang, Pyeongtaek-si (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/245,520

(22) Filed: Oct. 7, 2005

(30) Foreign Application Priority Data
Jan. 19, 2005 (KR) 2005-5051

(51) Int. Cl. H04B 10/04

(52) U.S. Cl. 398/188

(57) ABSTRACT

Disclosed is an optical transmitter using an offset quadrature phase-shift-keying (OQPSK) method. The method includes: a first phase modulator for outputting a first signal beam generated by phase-modulating an input beam based on a first data; a second phase modulator for outputting a second signal beam generated by phase-modulating the input beam based on a second data; a phase delay unit for granting a predetermined phase difference between the first signal beam and the second signal beam; and an optical coupler for coupling the first signal beam and the second signal beam between which the phase difference exists.

### CLAIM OF PRIORITY

This application claims priority under 35 U.S.C. § 119 to an application entitled “Offset Quadrature Phase-Shift-Keying Method and Optical Transmitter Using the Same,” filed in the Korean Intellectual Property Office on Jan. 19, 2005 and assigned Serial No. 2005-5051, the contents of which are incorporated herein by reference.

### BACKGROUND OF THE INVENTION

1. Field of the Invention

The present invention relates generally to an optical transmitter used in an optical communication system and more particularly, to an optical transmitter using an offset quadrature phase-shift-keying (OQPSK) method.

2. Description of the Related Art

Due to an increase in demand for a faster data rate via a backbone network, efforts are made to increase the transmission capacity using a single optical fiber. One way of improving the transmission capacity of an optical communication system is to increase the number of channels in the system using a wavelength division multiplexing (WDM) scheme. Another way is to increase frequency utilization which consists using a narrow channel bandwidth modulation scheme. In this method, more channels can be carried on a given bandwidth by narrowing the channel spacing. However, for a binary signal, more than 1-bit data cannot be carried on a unit frequency. This is supported by the Shannon's theory. Therefore, to increase the transmission capacity of the optical communication system, the number of bits per unit frequency needs to be increased using a non-binary modulation scheme instead of binary modulation scheme.

The non-binary modulation schemes popularized for the optical communication system include M-ary phase-shift-keying (PSK), quadrature phase-shift-keying (QPSK), and quadrature amplitude modulation (QAM) schemes. It is difficult to apply the M-ary PSK and QAM schemes for modulation to an optical communication system. In the M-ary PSK and QAM schemes, the receive sensitivity worsen as the number of bits per unit frequency increases. In contrast, in the QPSK scheme, 2 bits per unit frequency can be carried, thus relatively high receive sensitivity can be provided.

It is known that a QPSK optical transmitter provides, when used with a balanced receiver, twice as much transmission and 1.5 dB higher receive sensitivity than a conventional non return-to-zero (NRZ) optical communication system.

However, as well known in the optical communication system, the QPSK signal beam can be easily deteriorated by an optical filter having a narrow bandwidth, as a QPSK signal beam has a 180°-phase transition. Since an optical transport network includes a number of optical filters, the performance of an optical communication system adopting the QPSK scheme is limited.

As a result, there is a need for an improved modulation method for obtaining advantages of the QPSK scheme and simultaneously allowing less performance deterioration even if a signal beam passes through an optical filter having a narrow bandwidth and an optical transmitter using the same.

### SUMMARY OF THE INVENTION

One aspect of the present invention provides a modulation scheme capable of realizing the advantages of the QPSK scheme and minimizing performance deterioration even if a signal beam passes through an optical filter having a narrow bandwidth.

Another aspect of the present invention provides an optical transmitter using an offset quadrature phase-shift-keying (OQPSK) modulation method. The optical transmitter includes: a first phase modulator for outputting a first signal beam generated by phase-modulating an input beam based on a first data; a second phase modulator for outputting a second signal beam generated by phase-modulating the input beam based on a second data; a phase delay unit for granting a predetermined phase difference between the first signal beam and the second signal beam; and an optical coupler for coupling the first signal beam and the second signal beam between which the phase difference exists.

Another aspect of the present invention provides an optical transmitter using an offset quadrature phase-shift-keying (OQPSK) modulation method. The optical transmitter includes: a first phase modulator for outputting a first signal beam generated by phase-modulating an input beam based on a first data; a second phase modulator for outputting a second signal beam generated by phase-modulating the input beam based on a second data; a bit delay unit for granting a predetermined time difference between the first signal beam and the second signal beam; a phase delay unit for granting a predetermined phase difference between the first signal beam and the second signal beam; and an optical coupler for coupling the first signal beam and the second signal beam between which the phase difference and the time difference exist.

Another aspect of the present invention provides an offset quadrature phase-shift-keying (OQPSK) modulation method comprising the steps of: generating a first signal beam by phase-modulating a first beam based on a first data; generating a second signal beam by phase-modulating a second beam based on a second data; granting a predetermined phase difference between the first signal beam and the second signal beam; and coupling the first signal beam and the second signal beam between which the phase difference exists.

Another aspect of the present invention provides an offset quadrature phase-shift-keying (OQPSK) modulation method comprising the steps of: generating a first signal beam by phase-modulating a first beam based on a first data; generating a second signal beam by phase-modulating a second beam based on a second data; granting a predetermined time difference between the first signal beam and the second signal beam; granting a predetermined phase difference between the first signal beam and the second signal beam; and coupling the first signal beam and the second signal beam between which the phase difference and the time difference exist.

### BRIEF DESCRIPTION OF THE DRAWINGS

The above features and advantages of the present invention will become more apparent from the following detailed description when taken in conjunction with the accompanying drawings in which:

FIG. 1 is a block diagram of an optical transmitter using an OQPSK modulation method according to a first embodiment of the present invention;

FIG. 2 is a timing diagram of signal beams processed by the optical transmitter shown in FIG. 1;

FIG. 3 is a block diagram of an optical transmitter using an OQPSK modulation method according to a second embodiment of the present invention;

FIG. 4 is a timing diagram of signal beams processed by the optical transmitter shown in FIG. 3;

FIG. 5 is a block diagram of an optical transmitter using an OQPSK modulation method according to a third embodiment of the present invention;

FIG. 6 is a block diagram of an optical transmitter using an OQPSK modulation method according to a fourth embodiment of the present invention;

FIG. 7 is a block diagram of an optical transmitter using an OQPSK modulation method according to a fifth embodiment of the present invention; and

FIG. 8 is a timing diagram of signal beams processed by the optical transmitter shown in FIG. 7.

### DETAILED DESCRIPTION

Hereinafter, embodiments of the present invention will be described with reference to the accompanying drawings. In the drawings, the same or similar elements are denoted by the same reference numerals even though they are depicted in different drawings. For the purposes of clarity and simplicity, well-known functions or constructions are not described in detail as they would obscure the invention in unnecessary detail.

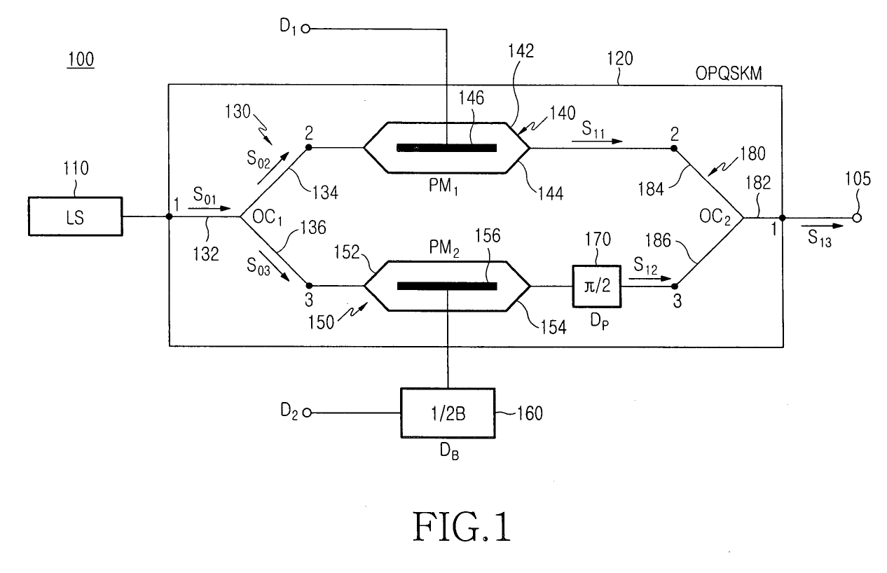

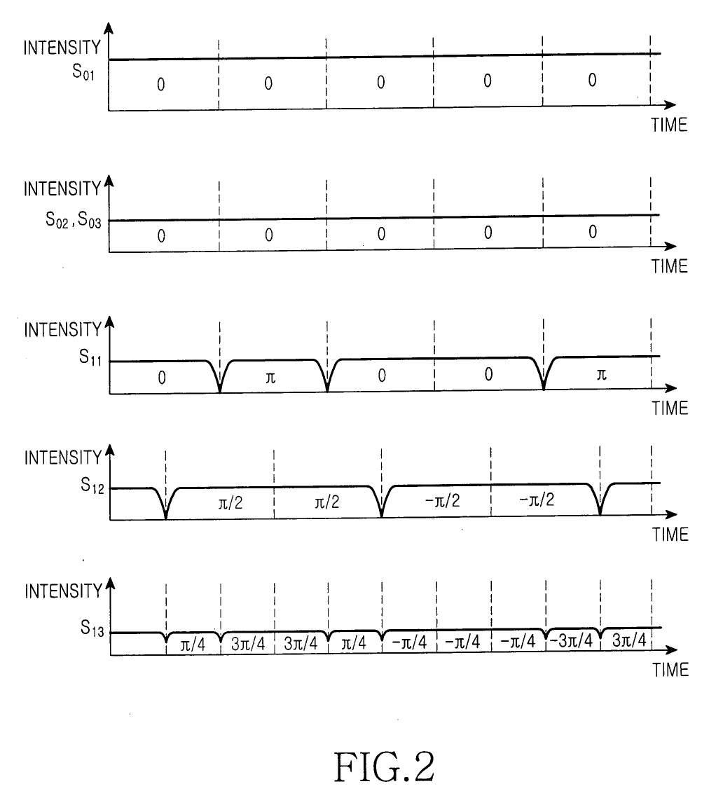

FIG. 1 is a block diagram of an optical transmitter 100 using an offset quadrature phase-shift-keying (OQPSK) modulation method according to a first embodiment of the present invention. FIG. 2 is a timing diagram of signal beams processed by the optical transmitter 100 shown in FIG. 1. As shown, the optical transmitter 100 includes a light source (LS) 110 and an OQPSK modulator (OQPSKM) 120. The OQPSKM 120 includes first and second optical couplers (OCs) 130 and 180, first and second phase modulators (PMs) 140 and 150, a phase delay unit D_{P} 170, and a bit delay unit D_{B} 160.

In operation, the LS 110 outputs a continuous waveform beam S₀₁ having a predetermined wavelength. The LS 110 may include a continuous wave (CW) laser for outputting the continuous waveform beam S₀₁.

The first OC 130 includes first to third ports, a root waveguide 132, first and second branch waveguides 134 and 136 that branch off in two directions from the root waveguide 132. The first port is coupled to the LS 110, the second port is coupled to the first PM 140, and the third port is coupled to the second PM 150. The first OC 130 power-splits the beam S₀₁ input from the first port equally into two (generates first and second split beams S₀₂ and S₀₃) and outputs the power-split first and second split beams S₀₂ and S₀₃ to the second and third ports, respectively. Each of the first and second OCs 130 and 180 may include a typical Y-branch waveguide or a typical directional optical coupler.

In FIG. 2, each horizontal axis indicates time, and each vertical axis indicates intensity. For example, the beam S₀₁ input through the first port of the first OC 130 has the intensity of 4 (a value assumed for convenience of description) and a phase of 0. That is, the input beam has uniform intensity and no phase transition. Accordingly, each of the first and second split beams S₀₂ and S₀₃ has the intensity of 2 and the phase of 0.

Returning to FIG. 1, the first PM 140 includes first and second arms 142 and 144, coupled to each other at both ends, and an electrode 146 for data supply. The first end of the first PM 140 is coupled to the second port of the first OC 130, and a second end is coupled to a second port of the second OC 180. The first PM 140 inputs the first split beam S₀₂ from the first OC 130 and outputs a first signal beam S₁₁ generated by phase-modulating the first split beam S₀₂ based on input first data D₁. The first data D₁ is a non return-to-zero (NRZ) electric signal, and in the present embodiment, the first data D₁ indicates a bitstream of “01001.” Each of the first and second PMs 140 and 150 outputs two types of phases. In the present embodiment, each of the first and second PM 140 and 150 outputs a 0 phase and a π phase. That is, “0” bit is output as the 0 phase, and “1” bit is output as the π phase. The first PM 140 outputs the first signal beam S₁₁ indicating a phase stream of “0, π, 0, 0, π” by phase-modulating the first split beam S₀₂ based on the input bitstream of “01001.” Each of the first and second PMs 140 and 150 may include an x-cut Mach-Zender modulator (MZM) having no frequency chirping or a z-cut MZM using a domain inversion scheme. Each of the first and second PMs 140 and 150 may include a PM having one waveguide. However it is preferable that each of the first and second PMs 140 and 150 includes an MZM for increasing accuracy of 0 and π phase transition. Here, a bias position of each of the first and second PMs 140 and 150 is located at a minimum point of a transfer curve, and a driving voltage of each of the first and second PMs 140 and 150 is twice as much as a switching voltage.

The bit delay unit D_{B} 160, which is coupled to an electrode 156 of the second PM 150, is an electric element for delaying input second data D₂ by ½ bit. The second data D₂ is a NRZ electric signal and indicates a bitstream of “00110” in the present embodiment. Prior to entering the bit delay unit D_{B} 160, the second data D₂ has a different waveform of that of the first data D₁. A time difference between the first data D₁ and the delayed second data D₂ is ½ bit.

The second PM 150 includes first and second arms 152 and 154, coupled to each other at both ends, and the electrode 156 for data supply. The first end of the second PM 150 is coupled to the third port of the first OC 130 and a second end is coupled to the phase delay unit D_{P} 170. The second PM 150 inputs the second split beam S₀₃ from the first OC 130 and outputs a second signal beam generated by phase-modulating the second split beam S₀₃ based on the delayed second data D₂ received by the electrode 156. The second PM 150 outputs the second signal beam indicating a ½ bit delayed phase stream of “0, 0, π, π, 0” by phase-modulating the second split beam S₀₃ based on the ½ bit delayed bitstream of “00110.”

The intensity of each of the first and second signal beams immediately drops to 0 due to offsetting interference as soon as the phase transition occurs from 0 to π or from π to 0.

The phase delay unit D_{P} 170 is deployed between the second PM 150 and a third port of the second OC 180 and delays the second signal beam input from the second PM 150 by a π/2 phase. The phase delay unit D_{P} 170, which controls a relative phase difference, makes the first signal beam S₁₁, output from the first PM 140, and the delayed second signal beam S₁₂, output from the second PM 150, achieve in-phase or quadrature phase against each other.

The second OC 180 includes first to third ports. The first port is coupled to an output end 150 of the optical transmitter 100, the second port is coupled to the second end of the first PM 140, and the third port is coupled to the phase delay unit D_{P} 170. The second OC 180 couples the first signal beam S₁₁ input through the second port and the delayed second signal beam S₁₂ input through the third port (generates an OQPSK signal beam S₁₃) and outputs the OQPSK signal beam S₁₃ through the first port.

The OQPSK signal beam S₁₃ has a bit period corresponding to ½ of bit period of the first and second data D₁ and D₂ and has four types of phase such as 0, π/2, −π/2, and π. That is, the OQPSK signal beam S₁₃ has a clock frequency corresponding to 2 times a clock frequency of the first and second data D₁ and D₂. Since there is no phase transition from 0 to π or from π to 0, an intensity variance due to the offsetting interference is relatively rare. This feature minimizes a non-linear effect when the OQPSK signal passes through a non-linear optical element.

In the first embodiment, the phase delay unit D_{P} 170 is deployed on the side of the second PM 150. However, since the phase delay unit D_{P} 170 controls the relative phase difference between the first and second signal beams, the phase delay unit D_{P} 170 can be deployed on the side of the first PM 140. In addition, the bit delay unit D_{B} 160 can be implemented by an optical element instead of the electric element.

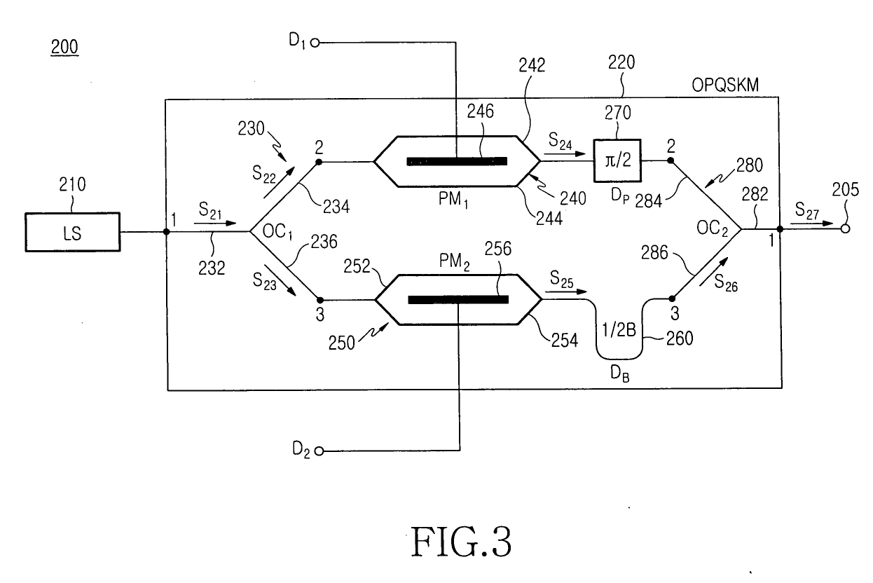

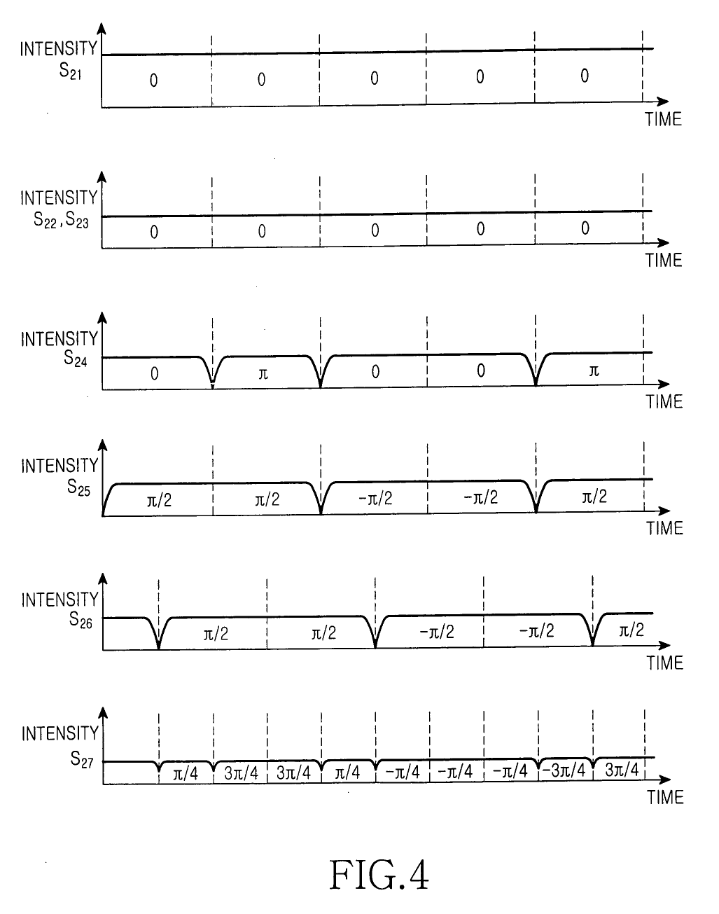

FIG. 3 is a block diagram of an optical transmitter 200 using an OQPSK modulation method according to a second embodiment of the present invention. FIG. 4 is a timing diagram of signal beams processed by the optical transmitter 200 shown in FIG. 3. The optical transmitter 200 in FIG. 3 has a similar configuration as the optical transmitter 100 shown in FIG. 1. The differences between two transmitters 100 and 200, however, are type and location of the bit delay unit and a location of the phase delay unit. Accordingly, overlapping description will be omitted to avoid redundancy. The optical transmitter 200 includes an LS 210 and an OQPSKM 220. The OQPSKM 220 includes first and second OC 230 and 280, first and second PM 240 and 250, a phase delay unit D_{P} 270, and a bit delay unit D_{B} 260.

The LS 210 outputs a continuous waveform beam S₂₁ having a predetermined wavelength.

The first OC 230 includes first to third ports, a root waveguide 232 and first and second branch waveguides 234 and 236 that branch off in two directions from the root waveguide 232. The first port is coupled to the LS 210, the second port is coupled to the first PM 240, and the third port is coupled to the second PM 250. The first OC 230 power-splits the beam S₂₁ input through the first port equally into two (generates first and second split beams S₂₂ and S₂₃) and outputs the power-split first and second split beams S₂₂ and S₂₃ to the second and third ports, respectively.

In FIG. 4, each horizontal axis indicates time, and each vertical axis indicates intensity. For example, the beam S₂, input through the first port of the first OC 230 has an intensity of 4 (a value assumed for convenience of description) and a phase of 0. That is, the input beam has uniform intensity and no phase transition. Accordingly, each of the first and second split beams S₂₂ and S₂₃ has the intensity of 2 and the phase of 0.

Returning to FIG. 3, the first PM 240 includes first and second arms 242 and 244, coupled to each other at both ends, and an electrode 246 for data supply. The first end of the first PM 240 is coupled to the second port of the first OC 230 and the second end is coupled to the phase delay unit D_{P} 270. The first PM 240 inputs the first split beam S₂₂ from the first OC 230 and outputs a first signal beam S₂₄ generated by phase-modulating the first split beam S₂₂ based on input first data D₁. The first data D₁ is an NRZ electric signal. Each of the first and second PMs 240 and 250 outputs two types of phases. In the present embodiment, each of the first and second PMs 240 and 250 outputs a 0 phase and a π phase. That is, “0” bit is output as the 0 phase, and “1” bit is output as the π phase. Here, a bias position of each of the first and second PMs 240 and 250 is located at a minimum point of a transfer curve, and a driving voltage of each of the first and second PMs 240 and 250 is twice as much as a switching voltage. The second PM 250 includes first and second arms 252 and 254, coupled to each other at both ends, and the electrode 256 for data supply. The first end of the second PM 250 is coupled to the third port of the first OC 230 and a second end is coupled to the bit delay unit D_{B} 260. The second PM 250 inputs the second split beam S₂₃ from the first OC 230 and outputs a second signal beam S₂₅ generated by phase-modulating the second split beam S₂₃ based on input second data D₂. The second data D₂ is an NRZ electric signal.

The bit delay unit D_{B} 260, deployed between the second end of the second PM 250 and a third port of the second OC 280, is an electric element for delaying the second signal beam S₂₅ input from the second PM 250 by ½ bit. The bit delay unit D_{B} 260 can be implemented by a waveguide having a length corresponding to the ½ bit.

The phase delay unit D_{P} 270 is deployed between the second end of the first PM 240 and a second port of the second OC 280 and delays the first signal beam S₂₄ input from the first PM 240 by a π/2 phase. The phase delay unit D_{P} 270, which controls the phase difference, enables the first signal beam S₂₄, output from the first PM 240, and the delayed second signal beam S₂₆, output from the bit delay unit D_{B} 260, achieve in-phase or quadrature phase against each other.

The second OC 280 includes first to third ports. The first port is coupled to an output end 205 of the optical transmitter 200, the second port is coupled to the phase delay unit D_{P} 270, and the third port is coupled to the bit delay unit D_{B} 260. The second OC 280 couples the delayed first signal beam input through the second port and the delayed second signal beam S₂₆ input from the third port (generates an OQPSK signal beam S₂₇) and outputs the OQPSK signal beam S₂₇ through the first port.

The OQPSK signal beam S₂₇ has a bit period corresponding to ½ times a bit period of the first and second data D₁ and D₂ and has four types of phases such as 0, π/2, −π/2 and π. Since there is no phase transition from 0 to π or from π to 0, the intensity variance due to the offsetting interference is relatively rare. This feature minimizes non-linear effect when the OQPSK signal passes through a non-linear optical element.

In the first and second embodiments, the OQPSK signal beam is an NRZ signal. However, the optical transmitter can be implemented to output a return-to-zero OQPSK (RZ-OQPSK) signal beam. The RZ-OQPSK signal beam has higher receive sensitivity without being influenced much by either the optical fiber non-linearity or polarization mode dispersion.

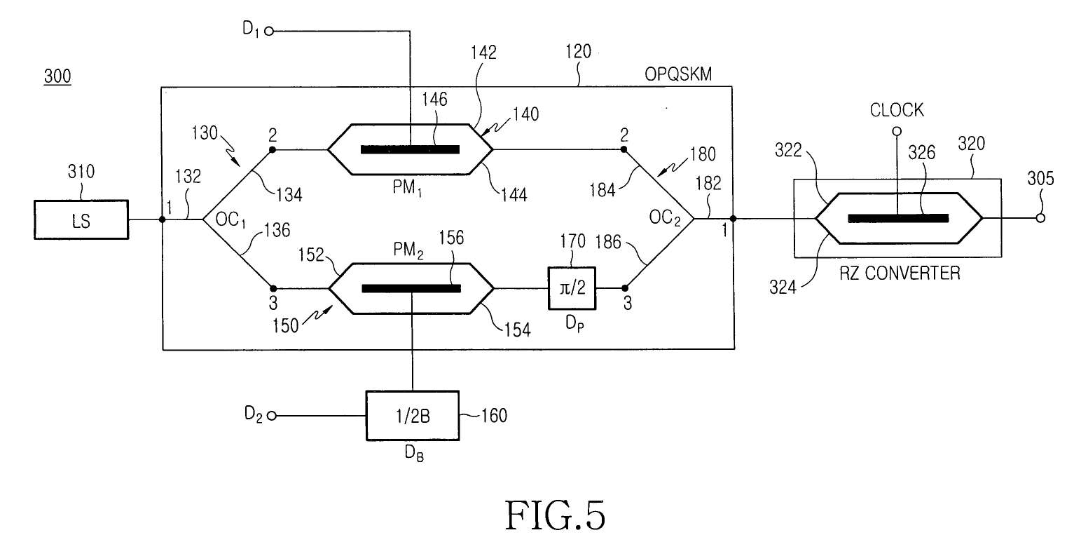

FIG. 5 is a block diagram of an optical transmitter 300 using an OQPSK modulation method according to a third embodiment of the present invention. Since the optical transmitter 300 uses the OQPSKM 120 shown in FIG. 1, the same elements shown in FIG. 1 are denoted by the same reference numerals, and an overlapping description will be omitted to avoid redundancy. The optical transmitter 300 includes an LS 310, the OQPSKM 120 and an RZ converter 320. The OQPSKM 120 includes the first and second OCs 130 and 180, the first and second PMs 140 and 150, the phase delay unit D_{P} 170, and the bit delay unit D_{B} 160.

The LS 310 outputs a continuous waveform beam having a predetermined wavelength. The LS 310 may include a CW laser for outputting the continuous waveform beam.

The OQPSKM 120 inputs a beam from the LS 310, has a bit period corresponding to ½ times a bit period of first and second data D, and D₂ and generates an OQPSKM signal beam having four types of phase such as 0, π/2, −π/2 and π. The first and second data D₁ and D₂ are NRZ signals.

The RZ converter 320 includes first and second arms 322 and 324, coupled to each other at both ends, and an electrode 326 for data supply. The first end of the RZ converter 320 is coupled to the OQPSKM 120, and a second end is coupled to an output end 305 of the optical transmitter 300. The RZ converter 320 outputs an RZ-OQPSK signal beam generated by modulating the OQPSKM signal beam, input from the OQPSKM 120, based on a sine wave clock signal having a frequency corresponding to two times a clock frequency of the first and second data D₁ and D₂. For example, when data rates of the first and second data D₁ and D₂ are 20 Gbps, the clock signal of the sine wave has a frequency of 40 GHz. As in RZ signal, the energy of the RZ-OQPSK signal beam jumps up from a 0 level to a 1 level and returns to the 0 level to indicate a 1 bit or 0 bit. The RZ-OQPSK signal beam has a bit period corresponding to ½ times a bit period of first and second data D₁ and D₂ and has four types of phase such as 0, π/2, −π/2 and π. The RZ converter 320 may include an x-cut MZM having no frequency chirping or a z-cut MZM using a domain inversion scheme. Here, a bias position of the RZ converter 320 is located at a minimum point of a transfer curve, and a driving voltage of the RZ converter 320 is twice as much as a switching voltage.

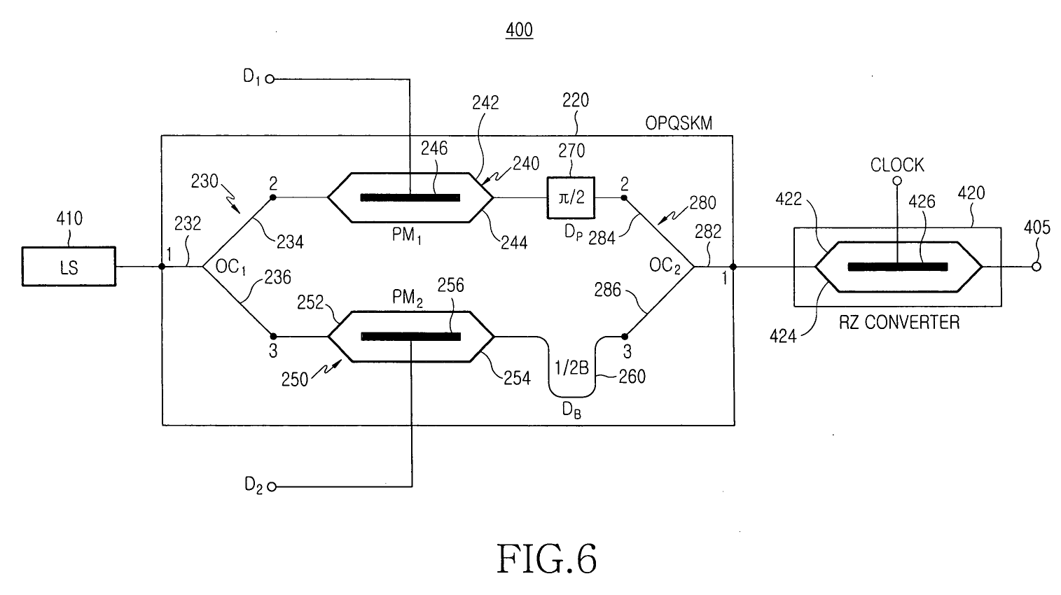

FIG. 6 is a block diagram of an optical transmitter 400 using an OQPSK modulation method according to a fourth embodiment of the present invention. Since the optical transmitter 400 uses the OQPSKM 220 shown in FIG. 3, the same elements shown in FIG. 3 are denoted by the same reference numerals, and an overlapped description will be omitted to avoid redundancy. The optical transmitter 400 includes an LS 410, the OQPSKM 220, and an RZ converter 420. The OQPSKM 220 includes the first and second OC 230 and 280, the first and second PM 240 and 250, the phase delay unit D_{P} 270, and the bit delay unit D_{B} 260.

The LS 410 outputs a continuous waveform beam having a predetermined wavelength. The LS 410 may include a CW laser for outputting the continuous waveform beam.

The OQPSKM 220 inputs a beam from the LS 410, has a bit period corresponding to ½ times a bit period of first and second data D₁ and D₂ and generates an OQPSKM signal beam having four types of phase such as 0, π/2, −π/2 and π. The first and second data D₁ and D₂ are NRZ signals

The RZ converter 420 includes first and second arms 422 and 424, coupled to each others at both ends, and an electrode 426 for data supply. The first end of the RZ converter 420 is coupled to the OQPSKM 220, and a second end is coupled to an output end 405 of the optical transmitter 400. The RZ converter 420 outputs an RZ-OQPSK signal beam generated by modulating the OQPSKM signal beam input from the OQPSKM 220 based on a sine wave clock signal having a frequency corresponding to two times a clock frequency of the first and second data D₁ and D₂. For example, when data rates of the first and second data D, and D₂ are 20 Gbps, the clock signal of the sine wave has a frequency of 40 GHz. As in RZ signal, the energy of the RZ-OQPSK signal beam jumps up from a 0 level to a 1 level and returns to the 0 level to indicate a 1 bit or 0 bit. The RZ-OQPSK signal beam has a bit period corresponding to ½ times a bit period of first and second data D₁ and D₂ and has four types of phase such as 0, π/2, −π/2 and π. The RZ converter 420 may include an x-cut MZM having no frequency chirping or a z-cut MZM using a domain inversion scheme. Here, a bias position of the RZ converter 420 is located at a minimum point of a transfer curve, and a driving voltage of the RZ converter 420 is twice as much as a switching voltage.

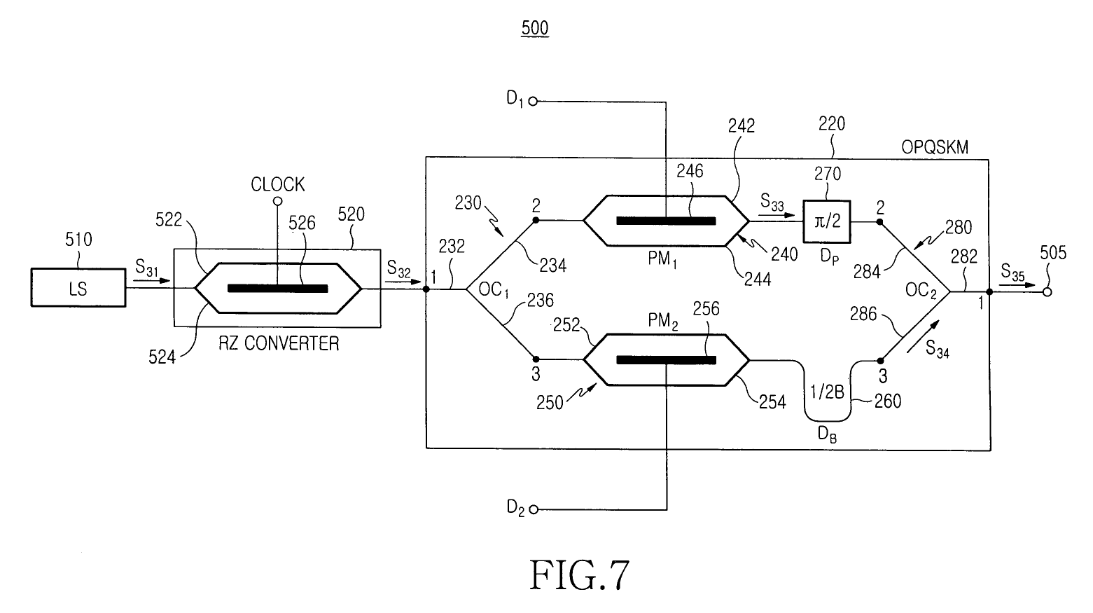

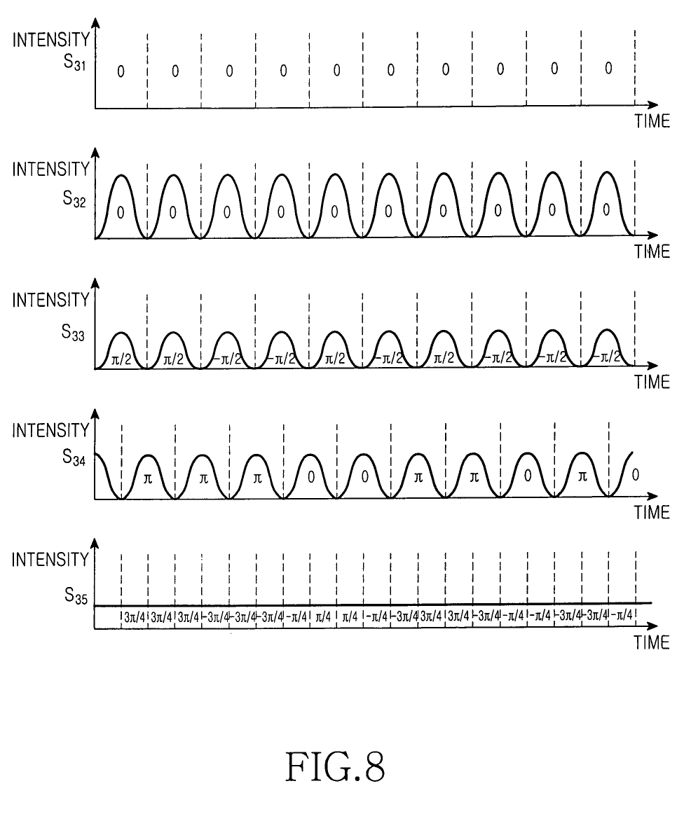

FIG. 7 is a block diagram of an optical transmitter 500 using an OQPSK modulation method according to a fifth embodiment of the present invention. FIG. 8 is a timing diagram of signal beams processed by the optical transmitter 500 shown in FIG. 7. Since the optical transmitter 500 uses the OQPSKM 220 shown in FIG. 3, the same elements shown in FIG. 3 are denoted by the same reference numerals, and an overlapped description will be omitted to avoid redundancy. The optical transmitter 500 includes an LS 510, an RZ converter 520 and the OQPSKM 220. The OQPSKM 220 includes the first and second OCs 230 and 280, the first and second PMs 240 and 250, the phase delay unit D_{P} 270, and the bit delay unit D_{B} 260.

The LS 510 outputs a continuous waveform beam S₃₁ having a predetermined wavelength. The LS 510 may include a CW laser for outputting the continuous waveform beam.

In FIG. 8, each horizontal axis indicates time, and each vertical axis indicates intensity. For example, the beam S₃₁ output from the LS 510 has the intensity of 4 (a value assumed for convenience of description) and a phase of 0. That is, the input beam has uniform intensity and no phase transition.

Returning to FIG. 7, the RZ converter 520 includes first and second arms 522 and 524, coupled to each other at both ends, and an electrode 526 for data supply. The first end of the RZ converter 520 is coupled to the LS 510, and a second end is coupled to the OQPSKM 220. The RZ converter 520 outputs an RZ signal beam S₃₂ generated by modulating the beam S₃₁ input from the LS 510 based on a sine wave clock signal having a frequency corresponding to a clock frequency of the first and second data D₁ and D₂. For example, when data rates of the first and second data D_{1 and D}₂ are 20 Gbps, the clock signal of the sine wave has a frequency of 20 GHz. As in RZ signal, the energy of the RZ signal beam S₃₂ jumps up from a 0 level to a 1 level and returns to the 0 level to indicate a 1 bit or 0 bit.

The first OC 230 includes the first to third ports, the root waveguide 232, and the first and second branch waveguides 234 and 236 that branch off in two directions from the root waveguide 232. The first port is coupled to the RZ converter 520, the second port is coupled to the first PM 240, and the third port is coupled to the second PM 250. The first OC 230 power-splits the beam S₂₁ input through the first port equally into two (generates first and second split beams) and outputs the power-split first and second split beams to the second and third ports, respectively.

The first PM 240 includes the first and second arms 242 and 244, coupled to each other at both ends, and the electrode 246 for data supply. The first end of the first PM 240 is coupled to the second port of the first OC 230, and the second end is coupled to the phase delay unit D_{P} 270. The first PM 240 inputs the first split beam from the first OC 230 and outputs a first signal beam S₃₃ generated by phase-modulating the first split beam based on input first data D₁. The first data D₁, is an NRZ electric signal. Each of the first and second PMs 240 and 250 outputs two types of phases. In the present embodiment, each of the first and second PM 240 and 250 outputs a 0 phase and a π phase. That is, “0” bit is output as the 0 phase, and “1” bit is output as the π phase. Here, a bias position of each of the first and second PM 240 and 250 is located at a minimum point of a transfer curve, and a driving voltage of each of the first and second PMs 240 and 250 is twice as much as a switching voltage.

The second PM 250 includes the first and second arms 252 and 254, coupled to each other at both ends, and the electrode 256 for data supply. The first end of the second PM 250 is coupled to the third port of the first OC 230 and the second end is coupled to the bit delay unit D_{B} 260. The second PM 250 inputs the second split beam from the first OC 230 and outputs a second signal beam generated by phase-modulating the second split beam based on input second data D₂.

The bit delay unit D_{B} 260, deployed between the second end of the second PM 250 and the third port of the second OC 280, is an optical element for delaying the second signal beam input from the second PM 250 by ½ bit. The bit delay unit D_{B} 260 can be implemented by a waveguide having a length corresponding to the ½ bit.

The phase delay unit D_{P} 270 is deployed between the second end of the first PM 240 and the second port of the second OC 280. The phase delay unit D_{P} 270 delays the first signal beam S₃₃ input from the first PM 240 by a π/2 phase. The phase delay unit D_{P} 270, which controls a relative phase difference, makes the first signal beam S₃₃, output from the first PM 240, and the delayed second signal beam S₃₄, output from the bit delay unit D_{B} 260, achieve in-phase or quadrature phase against each other.

The second OC 280 includes the first to third ports. The first port is coupled to an output end 505 of the optical transmitter 500, the second port is coupled to the phase delay unit D_{P} 270, and the third port is coupled to the bit delay unit D_{B} 260. The second OC 280 couples the delayed first signal beam input from the second port and the delayed second signal beam S₃₄ input from the third port (generates a minimum-shift-keying (MSK) signal beam S₃₅) and outputs the MSK signal beam S₃₅ through the first port.

The MSK signal beam S₃₅ has a bit period corresponding to ½ times a bit period of the first and second data D₁ and D₂, and an OQPSK signal beam having four types of phase such as 0, π/2, −π/2 and π is generated. Since the MSK signal beam S₃₅ does not vary in intensity, the MSK signal beam S₃₅ can be applied to an element, such as a semiconductor optical amplifier whose non-linearity varies in accordance with the intensity of an input beam, without much variation in non-linearity according to a modulation pattern. The phase of the MSK signal beam S₃₅ is represented with an integer multiplied by π/4 to indicate a phase of a signal beam on the center of a bit. Since the phase varies continuously according to the feature of the MSK signal beam S₃₅, the phase between bits does not vary substantially.

In the fifth embodiment, the OQPSKM 220 shown in FIG. 3 is used. However, the OQPSKM 120 shown in FIG. 1 can be used.

According to the embodiments of the present invention, an OQPSK modulation method and an optical transmitter using the same produces a signal beam without phase transition from 0 to π or from π to 0. Accordingly, the intensity variance due to offsetting interference is relatively slight, two bits per unit frequency can be carried on, and further relatively high receive sensitivity can be provided.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An optical transmitter using an offset quadrature phase-shift-keying (OQPSK) modulation method, comprising:
a first phase modulator for outputting a first signal beam generated by phase-modulating an input beam based on a first data;
a second phase modulator for outputting a second signal beam generated by phase-modulating the input beam based on a second data;
a phase delay unit for granting a predetermined phase difference between the first signal beam and the second signal beam; and
an optical coupler for coupling the first signal beam and the second signal beam between which the phase difference exists.

2. The optical transmitter of claim 1, wherein a time difference between the first data and second data is ½ bit, and the phase difference granted between the first and second signal beams is π/2.

3. The optical transmitter of claim 1, further comprising:
a light source for outputting a beam having a continuous waveform; and
an optical coupler for power-splitting the beam input from the light source equally into two and outputting the power-split beams to the first and second phase modulators, respectively.

4. The optical transmitter of claim 1, further comprising a return-to-zero (RZ) converter for modulating the signal beam input from the optical coupler based on a sine wave clock signal having a frequency corresponding to two times a clock frequency of the first and second data.

5. The optical transmitter of claim 1, further comprising:
a light source for outputting a beam having a continuous waveform;
an RZ converter for modulating the beam input from the light source based on a sine wave clock signal having a frequency corresponding to a clock frequency of the first and second data; and
an optical coupler for power-splitting the beam input from the RZ converter equally into two and outputting the power-split beams to the first and second phase modulators, respectively.

6. An optical transmitter using an offset quadrature phase-shift-keying (OQPSK) modulation method, comprising:
a first phase modulator for outputting a first signal beam generated by phase-modulating an input beam based on a first data;
a second phase modulator for outputting a second signal beam generated by phase-modulating the input beam based on a second data;
a bit delay unit for granting a predetermined time difference between the first signal beam and the second signal beam;
a phase delay unit for granting a predetermined phase difference between the first signal beam and the second signal beam; and
an optical coupler for coupling the first signal beam and the second signal beam between which the phase difference and the time difference exist.

7. The optical transmitter of claim 6, wherein the time difference between the first and second signals is ½ bit, and the phase difference granted between the first and second signal beams is π/2.

8. The optical transmitter of claim 6, further comprising:
a light source for outputting a beam having a continuous waveform; and
an optical coupler for power-splitting the beam input from the light source equally into two and outputting the power-split beams to the first and second phase modulators, respectively.

9. The optical transmitter of claim 6, further comprising a return-to-zero (RZ) converter for modulating the signal beam input from the optical coupler based on a sine wave clock signal having a frequency corresponding to two times a clock frequency of the first and second data.

10. The optical transmitter of claim 6, further comprising:
a light source for outputting a beam having a continuous waveform;
an RZ converter for modulating the beam input from the light source based on a sine wave clock signal having a frequency corresponding to a clock frequency of the first and second data; and
an optical coupler for power-splitting the beam input from the RZ converter equally into two and outputting the power-split beams to the first and second phase modulators, respectively.

11. An offset quadrature phase-shift-keying (OQPSK) modulation method comprising the steps of:
generating a first signal beam by phase-modulating a first beam based on first data;
generating a second signal beam by phase-modulating a second beam based on a second data;
granting a predetermined phase difference between the first signal beam and the second signal beam; and
coupling the first signal beam and the second signal beam between which the phase difference exists.

12. The method according to claim 11, wherein a time difference between the first data and second data is ½ bit, and the granted phase difference between the first and second signal beams is π/2.

13. An offset quadrature phase-shift-keying (OQPSK) modulation method comprising the steps of:
generating a first signal beam by phase-modulating a first beam based on a first data;
generating a second signal beam by phase-modulating a second beam based on a second data;
granting a predetermined time difference between the first signal beam and the second signal beam;
granting a predetermined phase difference between the first signal beam and the second signal beam; and
coupling the first signal beam and the second signal beam between which the phase difference and the time difference exist.

14. The method according to claim 13, wherein the granted time difference between the first and second beams is ½ bit, and the granted phase difference between the first and second signal beams is π/2.
